(19) United States
(12) Patent Application Publication
(10) Pub. No.: US 2019/0308265 A1
(43) Pub. Date: Oct. 10, 2019

(54) Wire Feeder for Manual or Automatic Circuit Board Insertion

(71) Applicant: DIVERSIFIED TECHNOLOGY GROUP, INC., Largo, FL (US)

(72) Inventors: Roy VanNostran, Seminole, FL (US); Phil Frisella, Clearwater, FL (US)

(73) Assignee: DIVERSIFIED TECHNOLOGY GROUP, INC., LARGO, FL (US)

(21) Appl. No.: 15/947,912

(22) Filed: Apr. 9, 2018

(51) Int. Cl. B23K 3/06

(52) U.S. Cl. CPC B23K 3/063

(57) ABSTRACT

A wire feeder is supplied with a bundle of pre-cut wires held substantially vertical orientation in a wire bin. Through gravity and optionally through vibration, a single strand from the bundle of pre-cut wires falls through a hole in the bottom of the bin, either for hand placement or for automatic placement. The floor of the bin is sloped to help migrate the strands of wire towards the hole in the bottom of the bin.

### FIELD

This invention relates to the field of electronic circuit assembly and more particularly to an apparatus for feeding single sections of wire.

### BACKGROUND

Circuit assembly often includes installing components in/on a circuit board. Although, for many modern circuit boards, components are often surface mounted and wave soldered, there still remains many applications in which through-hole insertion of components is performed, especially in high current capacity circuits such as power switching, power transfer, and surge protection circuits.

One such component that needs to be installed utilizing though-hole techniques is wire. A simple component, yet often requiring care and time to install. Often wire comes in spools, requiring cutting, stripping and tinning (coating with solder) before inserting into the through-hole of a printed circuit board. In such past operations, besides the added time to cut, strip, and tin, the wire often retained an arced shape from being on the spool, though it is often desired that the wire be straight.

Another technique for installing wires into through-holes is to use pre-cut, pre-stripped, and pre-tinned sections of wire. This technique is good for keeping the wire straight and quicker for installing as there is no need to cut, strip, and tin the wire during assembly, but it is often difficult to pick up a single section of wire that is, for example, in a bundle of wire, typically laying horizontally in a tray.

What is needed is an apparatus that will present a single section of pre-cut wire for installation into a through-hole of a circuit board of other uses.

### SUMMARY

A wire feeder is supplied with a bundle of wire strands held substantially vertical orientation in a bin. Through gravity and optionally through vibration, a single strand from the bundle falls through a hole in the bottom of the bin, either for hand placement or for automatic placement. The floor of the bin is sloped to migrate the strands of wire towards the hole in the bottom of the bin.

In one embodiment, a wire feeder is disclosed including a wire bin for holding a plurality of pre-cut wires in a substantially vertical orientation. A floor of the wire bin has a hole for passing of a single wire of the pre-cut wires there through. A wire feed tube is interfaced to the hole in the floor of the wire bin on a side of the hole opposite from the plurality of pre-cut wires for receiving a single wire of the pre-cut wires and a landing pad is situated below the wire feed tube. The landing pad captures an end of the single wire after the single wire falls through the hole.

In another embodiment, a wire feeder is disclosed including a device for holding a plurality of pre-cut wires in a substantially vertical orientation. A floor of the device for holding has a hole that is sized for passing of a single wire of the pre-cut wires therethrough. A wire feed tube is interfaced to the hole in the device for holding opposite from the plurality of pre-cut wires. A device for capturing an end of the single wire after the single wire falls through the hole is positioned beneath the feed tube.

In another embodiment, a wire feeder is disclosed including a wire bin for holding a plurality of pre-cut wires in a substantially vertical orientation. A floor of the wire bin has a hole that is sized for passing of a single wire of the pre-cut wires therethrough. The floor of the wire bin is sloped downward in a funnel shape culminating in the hole. A wire feed tube is interfaced to the hole on a side of the floor that is opposite from the plurality of pre-cut wires. The wire feed tube has a longitudinal slit. A landing pad is situated below the wire feed tube for capturing an end of the single wire after the single wire falls through the hole.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a wire feeder.

FIG. 2 illustrates a side elevational view of the wire feeder.

FIG. 3 illustrates a front elevational view of the wire feeder.

FIG. 4 illustrates a cross sectional view of the wire feeder.

FIG. 5 illustrates a plan view of the bottom of a wire bin of the wire feeder.

FIG. 6 illustrates a plan view of an alternate bottom of a wire bin of the wire feeder.

FIG. 7 illustrates a plan view of a second alternate bottom of a wire bin of the wire feeder.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

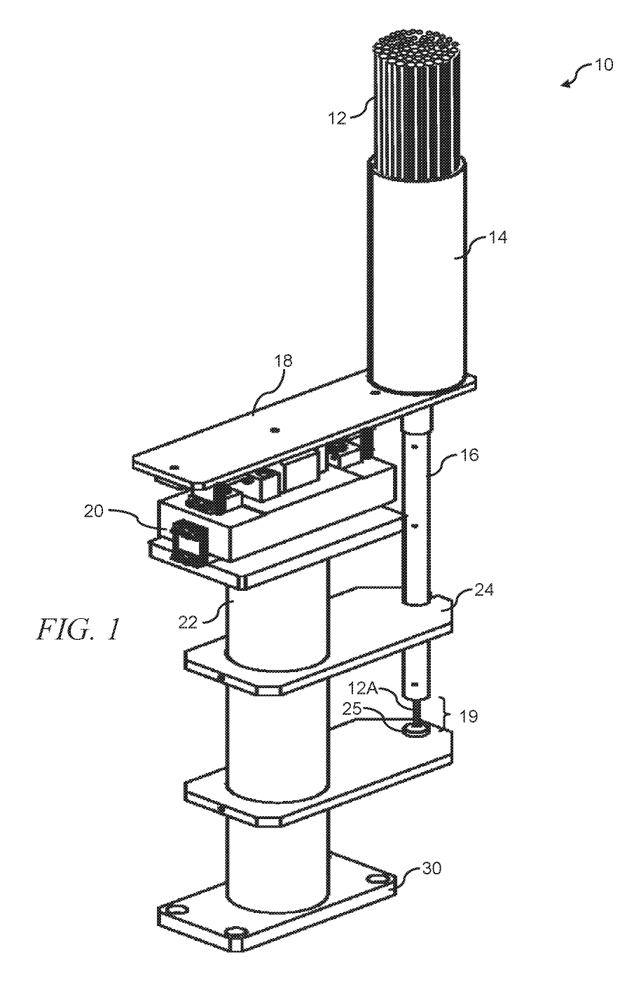

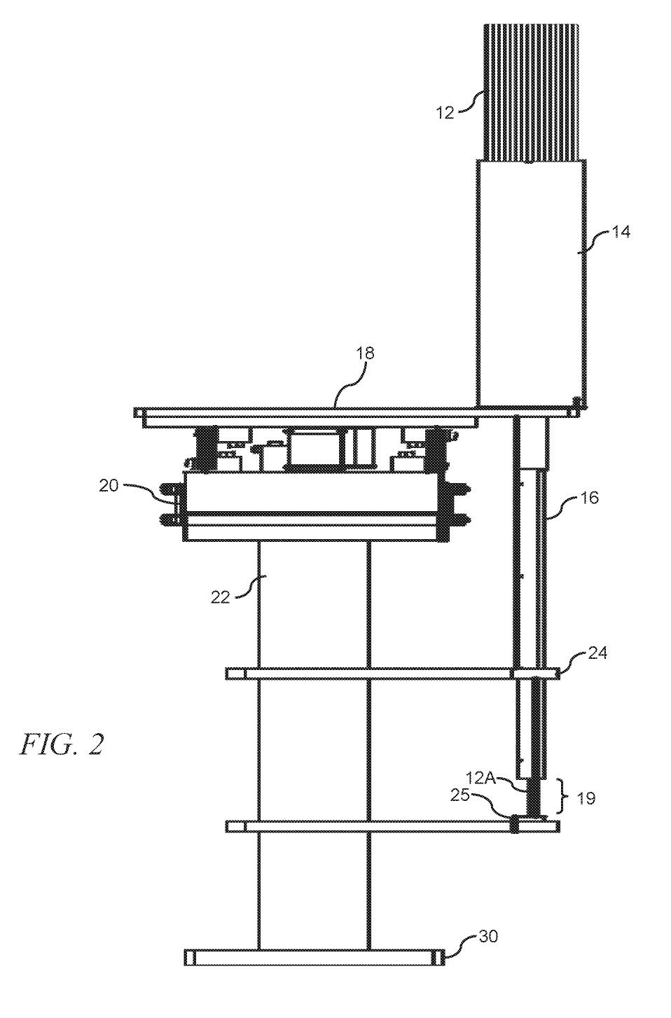

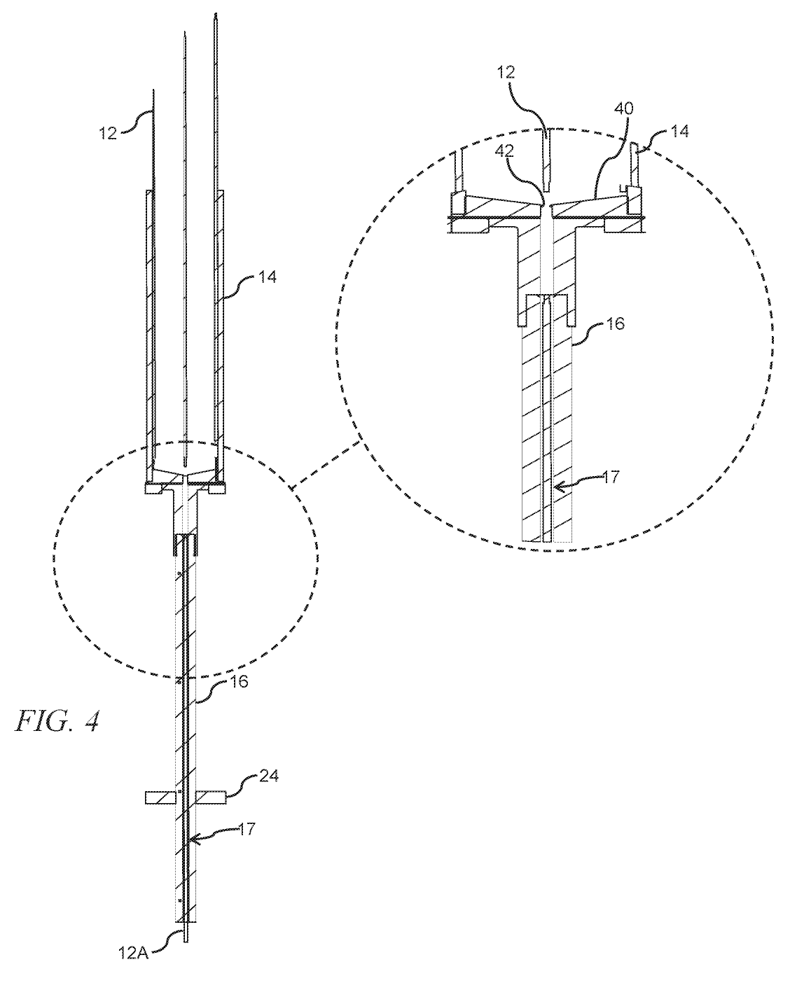

Referring to FIGS. 1 through 3, views of the wire feeder 10 are shown. The wire bin 14 holds a bundle (one or more) of pre-cut wires 12, preferably pre-stripped and pre-tinned. The wires rest on a floor 40 (inside surface, see FIG. 4) of a floor of the wire bin 14 in a generally vertical orientation, though some leaning is anticipated as the number of pre-cut wires 12 lessens. Through gravity and, optionally, through vibration provided from a vibration emitting device 20, one of the pre-cut wires 12 migrates to the center of the inside surface of the floor 40 of the wire bin 14 and this one of the pre-cut wires 12 falls through the hole 42 (see FIG. 4) in the inside surface of the floor 40 of the wire bin 14 for picking and placement. The single pre-cut wire 12A that has fallen through the hole 42 in the inside surface of the floor 40 of the wire bin 14 stops and rests on a landing pad 25 until the single pre-cut wire 12A is removed from the wire feed tube 16 by an end effector or an installer's hand grasping the single pre-cut wire 12A at the grab point or gap 19. This grab point is a gap between a bottom edge of the wire feed tube 16 and the landing pad 25. In some embodiments, the circuit board through-hole is positioned over the landing pad 25 and the single pre-cut wire 12A falls into the through-hole (not shown for clarity reasons). The landing pad 25 is for capturing the single pre-cut wire 12A until it is taken by the end effector or by the installer's hand.

The hole 42 is preferably sized slightly larger than an outer diameter of the pre-cut wires 12 so that only a single pre-cut wire 12 fits through the hole 42 at one time. Therefore, it is anticipated that the wire feeder 10 be arranged to interchange the wire bins 14 and/or inside surface of the floor 40 of the wire bin 14 to accommodate different gauges of the pre-cut wires 12.

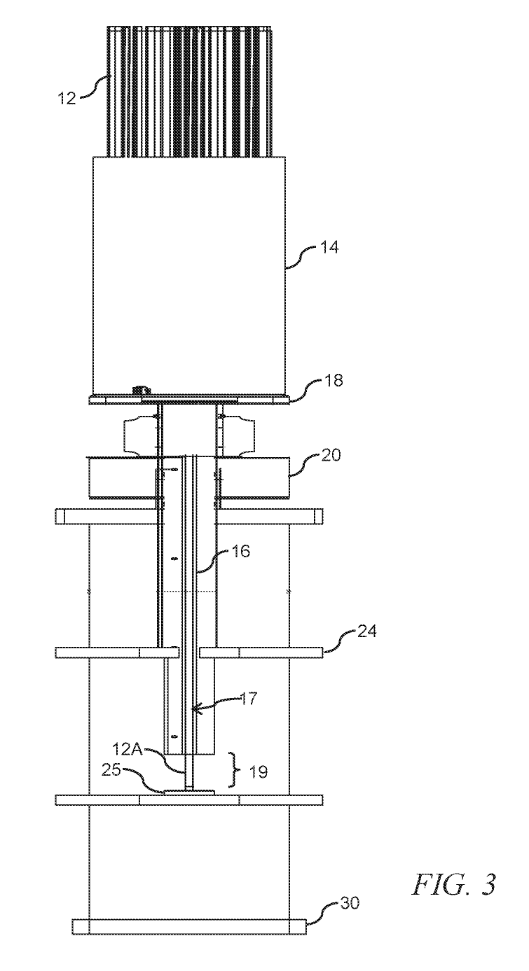

To enable removal of the single pre-cut wire 12A from the wire feed tube 16, the wire feed tube 16 is open in front, having a longitudinal slit 17 as visible in FIG. 3. In a preferred embodiment, the cross-sectional shape of the feed tube is that of a ‘C.’

When present, the vibration emitting device 20 provides vibration to the inside surface of the floor 40 of the wire bin 14 of the wire bin 14 through a vibration transmission plate 18.

For completeness, a mounting tower 22 supports the vibration emitting device 20, the wire bin 14, and the wire feed tube 16 is supported by support plates 24. A plate 30 at a bottom end of the mounting tower 22 is typically fastened to a surface

Referring to FIG. 4, a cross sectional view of the wire feeder 10 is shown. In this, the wire bin 14 is shown with only two of the pre-cut wires 12 present for clarity, one of the pre-cut wires 12 positioned over the hole 42 and ready for feeding through the hole 42 after the single pre-cut wire 12A is removed from the longitudinal slit 17 in the wire feed tube 16. Note the slope of the floor 40 of the wire bin 14 is angled and shaped like a funnel to migrate the pre-cut wires 12 towards the hole 42 for feeding into the wire feed tube 16 after the single pre-cut wire 12A is removed from the longitudinal slit 17A (e.g. by hand or by an end effector). This funnel shape aids in the migration of the pre-cut wires 12 towards the hole. This migration is optionally aided by vibration from the optional vibration emitting device 20 when present. It is preferred that the inside surface of the floor 40 is smooth with low friction to enhance migration of the pre-cut wires 12 towards the hole 42 in the inside surface of the floor 40 of the wire bin 14.

It is also anticipated that the edge is tapered where the hole 42 is formed in the floor 40 to improve migration of the pre-cut wires 12 into the hole 42.

It is also anticipated that the wire bin 14 be interchangeable to accommodate different gauge wires 12.

It is also anticipated that the floor 40 of the wire bin 14 be exchangeable including or separate from the wire bin 14. In embodiments in which the floor 40 of the wire bin 14 or the wire bin 14 itself are exchangeable, it is anticipated that the hole 42 be sized to accommodate one strand of the expected gauge of the wire 12.

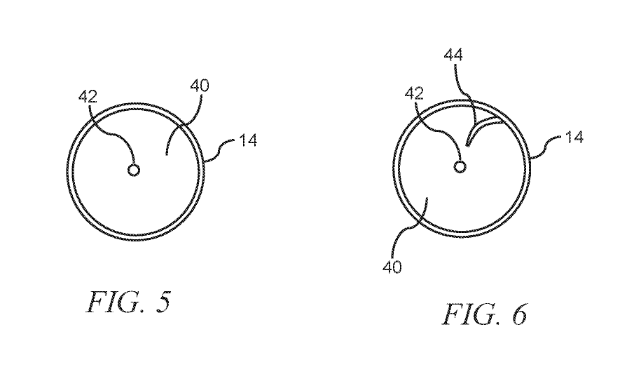

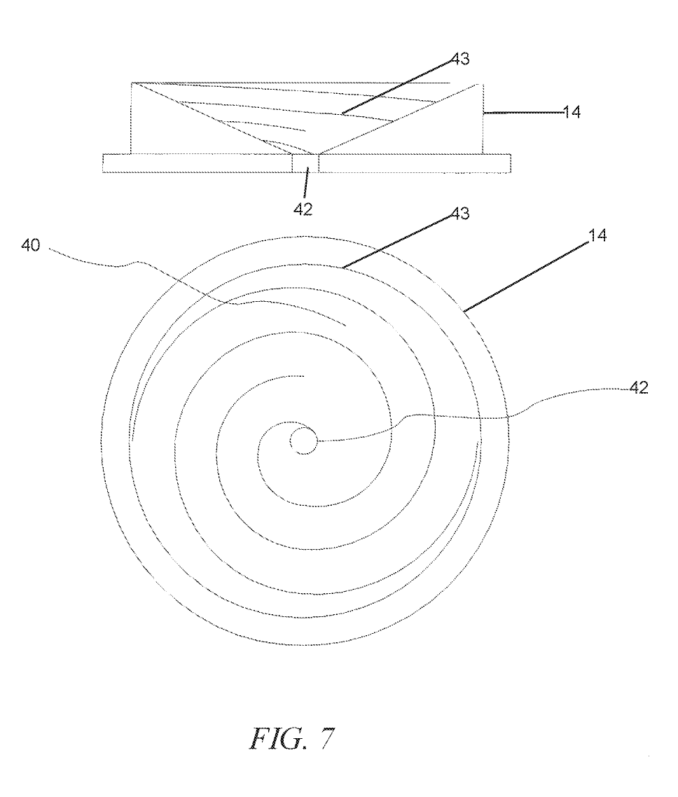

Referring to FIGS. 5,6, and 7 plan views of the floor 40 of a wire bin 14 of the wire feeder 10 are shown. In FIG. 6, the inside surface of the floor 40 of the wire bin 14 has a wire guiding gate 44 while in FIG. 7, the inside surface of the floor 40 of the wire bin 14 has spiral or helix grooves 43. The spiral or helix grooves 43 are formed or milled into the surface of the floor 40 of the wire bin 14. These are especially useful in embodiments having the vibration emitting device 20. The vibration invokes rotational traveling of the pre-cut wires 12 around a center of the inside surface of the floor 40 of the wire bin 14 (e.g. counter-clockwise rotation in the northern hemisphere). The wire guiding gate 44 and/or the spiral grooves 43 helps direct the pre-cut wires 12 towards the center of the floor 40 for engagement with the hole 42 in the inside surface of the floor 40 of the wire bin 14. As shown in FIG. 5, in some embodiments, there is no wire guiding gate 44 or spiral/helix grooves 43.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A wire feeder comprising:
a wire bin for holding a plurality of pre-cut wires in a substantially vertical orientation, a floor of the wire bin having a hole, the hole for passing of a single wire of the pre-cut wires therethrough;
a wire feed tube interfaced to the hole in the floor of the wire bin on a side of the hole that is distal from the plurality of pre-cut wires;
a landing pad situated below the wire feed tube, the landing pad for capturing an end of the single wire after the single wire falls through the hole; and
a gap between a bottom edge of the wire feed tube and the landing pad, the gap for grasping the single wire by a hand or by an end effector.

2. The wire feeder of claim 1, wherein the floor of the wire bin is sloped downward in a funnel shape culminating in the hole.

3. The wire feeder of claim 2, wherein the floor of the wire bin includes a wire guiding gate.

4. The wire feeder of claim 2, wherein the floor of the wire bin has a spiral groove for migrating the pre-cut wires towards the hole.

5. The wire feeder of claim 1, further comprising means for vibrating interfaced to the floor of the wire bin for invoking migration of the plurality of pre-cut wires towards the hole.

6. The wire feeder of claim 1, wherein the wire bin is tubular and the floor of the wire bin has a circular shape, the hole being located central to the floor.

7. The wire feeder of claim 1, wherein the wire bin and wire feed tube are supported by a mounting tower and support plates.

8. The wire feeder of claim 1, further comprising a guiding gate on the floor of the wire bin, the guiding gate urging the plurality of pre-cut wires towards the hole in the floor of the wire bin.

9. The wire feeder of claim 1, wherein each of the plurality of pre-cut wires are substantially linear, stripped and tinned.

10. The wire feeder of claim 1, further comprising a longitudinal slit in the wire feed tube for removing the single wire from the feed tube.

11. (canceled)

12. A wire feeder comprising:
means for holding a plurality of pre-cut wires in a substantially vertical orientation, the means for holding having walls and a floor, the floor of the means for holding having a hole, the hole sized for passing of a single wire of the pre-cut wires therethrough;
a wire feed tube interfaced to the hole in the means for holding opposite from the plurality of pre-cut wires;
a landing pad situated below the wire feed tube, the landing pad for capturing an end of the single wire after the single wire falls through the hole; and
a gap between a bottom edge of the wire feed tube and the landing pad, the gap for grasping the single wire by a hand or by an end effector.

13. The wire feeder of claim 12, wherein the floor of the means for holding is sloped downward in a funnel shape culminating in the hole.

14. The wire feeder of claim 13, wherein the floor of the wire bin includes a wire guiding gate.

15. The wire feeder of claim 13, wherein the floor of the wire bin has a spiral groove for migrating the pre-cut wires towards the hole.

16. The wire feeder of claim 12, further comprising means for vibrating interfaced to the floor of the means for holding for invoking migration of the plurality of pre-cut wires towards the hole.

17. The wire feeder of claim 12, further comprising a guiding gate on the floor of the means for holding, the guiding gate urging the plurality of pre-cut wires towards the hole in the floor of the means for holding.

18. The wire feeder of claim 12, further comprising a longitudinal slit in the wire feed tube for removing the single wire from the feed tube.

19. (canceled)

20. A wire feeder comprising:
a wire bin for holding a plurality of pre-cut wires in a substantially vertical orientation, a floor of the wire bin having a hole, the hole is sized for passing of a single wire of the pre-cut wires therethrough, the floor of the wire bin is sloped downward in a funnel shape culminating in the hole;
a wire feed tube interfaced to the hole on a side of the floor that is opposite from the plurality of pre-cut wires, the wire feed tube having a longitudinal slit;
a landing pad situated below the wire feed tube, the landing pad for capturing an end of the single wire after the single wire falls through the hole; and
a gap between a bottom edge of the wire feed tube and the landing pad, the gap for grasping the single wire by a hand or by an end effector.

21. The wire feeder of claim 20, further comprising means for vibrating interfaced to the floor of the wire bin for invoking migration of the plurality of pre-cut wires towards the hole.

22. The wire feeder of claim 20, wherein the wire bin is tubular and the floor has a circular shape, the hole being located central to the floor.

23. The wire feeder of claim 20, further comprising a guiding gate on the floor of the wire bin, the guiding gate urging the plurality of pre-cut wires towards the hole in the floor of the wire bin.

24. (canceled)
